(19) United States
(12) Patent Application Publication
(10) Pub. No.: US 2026/0221688 A1
(43) Pub. Date: Jul. 30, 2026

(54) CONNECTOR ASSEMBLY

(71) Applicant: Drapho Electronics Technology Co.,Ltd, Suzhou City (CN)

(72) Inventors: Yongfa Wu, Suzhou City (CN); ZhiHong Fang, Suzhou City (CN)

(21) Appl. No.: 19/303,511

(22) Filed: Aug. 19, 2025

(30) Foreign Application Priority Data
Dec. 30, 2024 (CN) 202423282729.0

(51) Int. Cl. H01R 13/627; H01R 12/72; H01R 12/75

(52) U.S. Cl. CPC H01R 13/6275; H01R 12/722; H01R 12/75

(57) ABSTRACT

A connector assembly, comprising a wire-end plug and a board-end socket. The wire-end plug includes an insulating body, a plurality of connecting terminals, a plurality of cables, and a pair of locking members mounted on the insulating body. The board-end socket includes a plastic base body, a plurality of sheet-shaped terminals, and a pair of fixing members. The locking member is plate-shaped and has a protrusion provided on its surface. The fixing member is provided with a sheet-shaped outer inserting plate and an inner inserting foot. The outer inserting plate and the inner inserting foot are integrally connected by an arc-shaped portion. The arc-shaped portion is provided with a snap-fit protuberant portion that snap-fit engages with the protrusion.

### CROSS-REFERENCE TO RELATED APPLICATIONS

This application claims the benefit of Chinese Patent Application No. 202423282729.0, filed on December 30, 2024, which is incorporated herein by reference in its entirety.

### TECHNICAL FIELD

The present disclosure relates to the field of electrical connection, and particularly to a connector assembly.

### BACKGROUND

With the development trend towards miniaturization and thinning of consumer electronic products such as notebook computers, tablet computers, and mobile phones, the design and manufacturing process requirements for their components are becoming increasingly higher. As products become increasingly thinner, their internal space becomes very narrow, requiring densely packed layouts inside the products. The volume of various electronic components is also becoming smaller and thinner, imposing higher demands on process technology and the reliability of product connections. Taking connector assemblies as an example, to meet the reliability of plugging and unplugging, the prior art usually designs corresponding snap-fit mechanisms on the plug and socket, enabling stable connection after insertion through these mechanisms. Common snap-fit mechanisms are arranged on both sides of the plug and socket, such as grooves provided on the insulating plastic on both sides of the plug to snap-fit with protruding structures on both sides of the socket. However, due to the thin design of the products, the retention force/holding force provided by such snap-fit mechanisms is insufficient, making them prone to loosening during vibration, leading to poor contact between the plug and socket.

### SUMMARY

The technical problem solved by the disclosure is to provide a connector assembly to improve the problem of poor contact caused by insufficient insertion/extraction force or holding force in the prior art.

To solve the above technical problem, the disclosure adopts the following technical solution: a connector assembly, comprising a wire-end plug and a board-end socket that being mutually pluggable, the wire-end plug including an insulating body, a plurality of connecting terminals received within the insulating body, a plurality of cables connected to the connecting terminals, and a pair of locking members mounted on the insulating body; the board-end socket including a plastic base body, a plurality of sheet-shaped terminals held on the plastic base body, and a pair of fixing members mounted on the plastic base body; wherein each locking member is plate-shaped and has a protrusion provided on its surface, each fixing member is provided with a sheet-shaped outer inserting plate and an inner inserting foot downwardly bent and extended from a top of the outer inserting plate, the outer inserting plate and the inner inserting foot are integrally connected by an arc-shaped portion, and the arc-shaped portion is provided with a snap-fit protuberant portion that snap-fit engages with the protrusion.

Further, the plastic base body is provided with a main body extending longitudinally, a pair of mounting arms forwardly extending from two longitudinal ends of the main body, and a bottom plate forwardly and horizontally extending from a bottom of the main body and located between the pair of mounting arms; an inner wall, an outer wall, and an inserting slot between the inner wall and the outer wall are formed on each mounting arm.

Further, the pair of mounting arms and the main body constitute a U-shaped structure, and an inserting area for accommodating the wire-end plug is formed between the pair of mounting arms and the main body; a recessed portion is formed on the surface of the inner wall facing the inserting area, the recessed portion and the inserting slot are respectively located on the inner and outer sides of the inner wall and together accommodate the fixing member.

Further, each mounting arm is further provided with a limiting portion located below the recessed portion, a limiting hole for accommodating the inner inserting foot is formed on the limiting portion.

Further, an opening recessed downward is formed on the outer wall, the opening inwardly penetrates through the inserting slot.

Further, each sheet-shaped terminal is F-shaped, and is provided with a contact portion, a soldering portion, and a holding portion; the contact portion is sheet-shaped and vertically disposed on the bottom plate.

Further, the insulating body is provided with a top wall, a bottom wall, a pair of side walls, a front end wall, and a rear end wall, a surface of the top wall is a flat surface, two rows of notches are formed on the bottom wall, the two rows of notches are separated by a groove.

Further, a recessed portion and a beam portion located within the recessed portion are formed on the pair of side walls, a locking member is plate-shaped and inserted into a side wall along a front-rear direction, the locking member is vertically disposed within the side wall and exposed within the recessed portion; the protrusion is located within the recessed portion.

Further, the locking member is provided with a narrow front end portion and a wide rear end portion, the protrusion is formed on the rear end portion.

Compared with the prior art, the disclosure achieves snap-fit engagement between the pair of locking members on the wire-end plug and the pair of fixing members on the board-end socket. Due to the provision of the protrusion on the locking member, the engagement between the locking member and the fixing member achieves good snap-fit effect and operational feel. Since both are made of metal material, they possess better strength, resulting in stronger retention force between them, which may meet the requirements for frequent plugging and unplugging.

### BRIEF DESCRIPTION OF THE DRAWINGS

FIG. 1 is a perspective view of the wire-end plug and the board-end socket of the connector assembly according to the disclosure when plugged together.

FIG. 2 is a top view of the wire-end plug and the board-end socket of the connector assembly according to the disclosure when plugged together.

FIG. 3 is an exploded view of the connector assembly according to the disclosure with the bottom surface of the wire-end plug facing upwards.

FIG. 4 is an exploded view of the board-end socket of the connector assembly according to the disclosure.

FIG. 5 is a perspective view of the fixing member of the board-end socket according to the disclosure.

FIG. 6 is a cross-sectional view of the wire-end plug and the board-end socket of the connector assembly according to the disclosure when plugged together.

FIG. 7 is a partial enlarged view of the wire-end plug and the board-end socket of the connector assembly according to the disclosure when plugged together.

### DETAILED DESCRIPTION

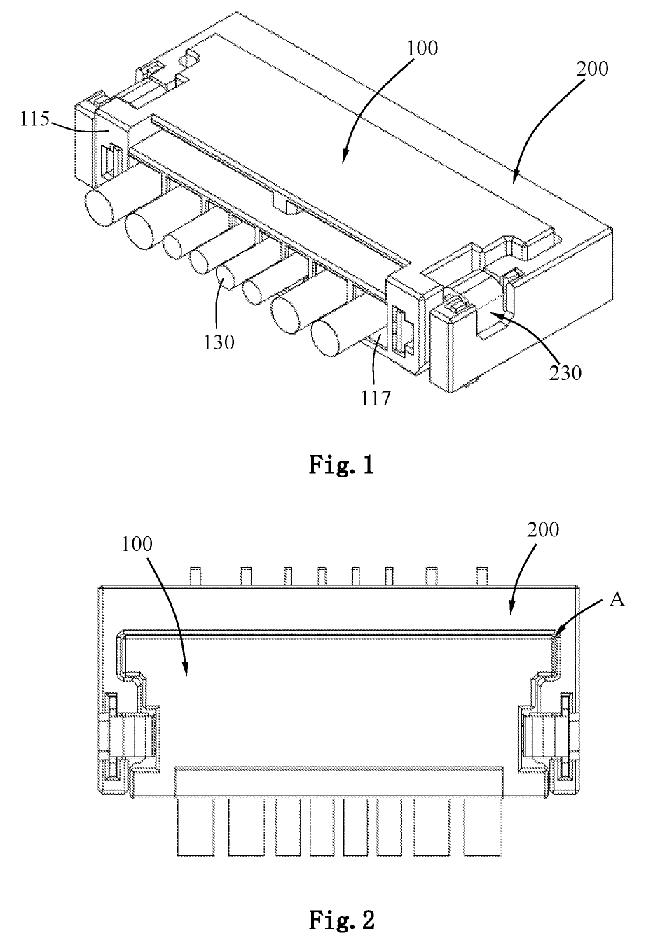

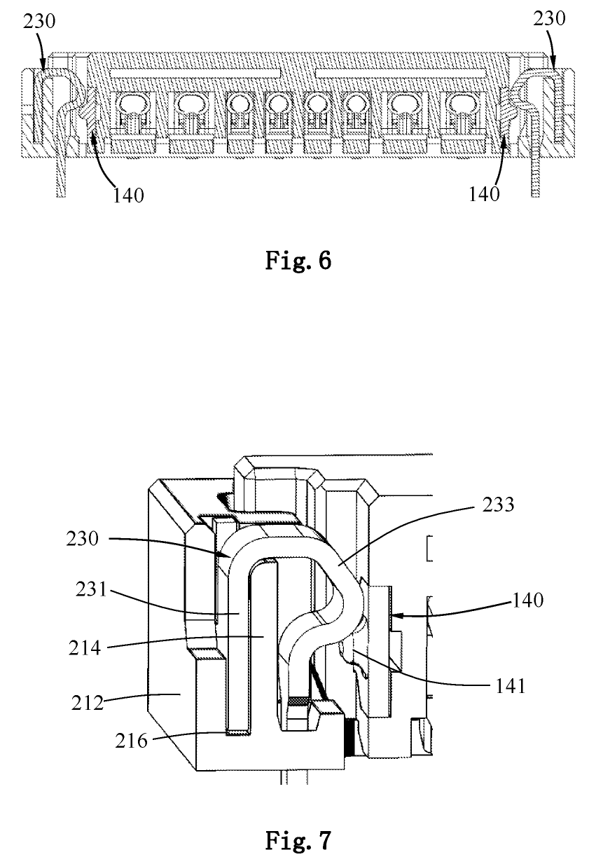

Please refer to FIG. 1 to FIG. 7. The disclosure provides a connector assembly, comprising a wire-end plug 100 and a board-end socket 200, which are respectively used for connecting cables and a circuit board. The wire-end plug 100 is inserted into the board-end socket 200 to achieve electrical connection between the cables and the circuit board.

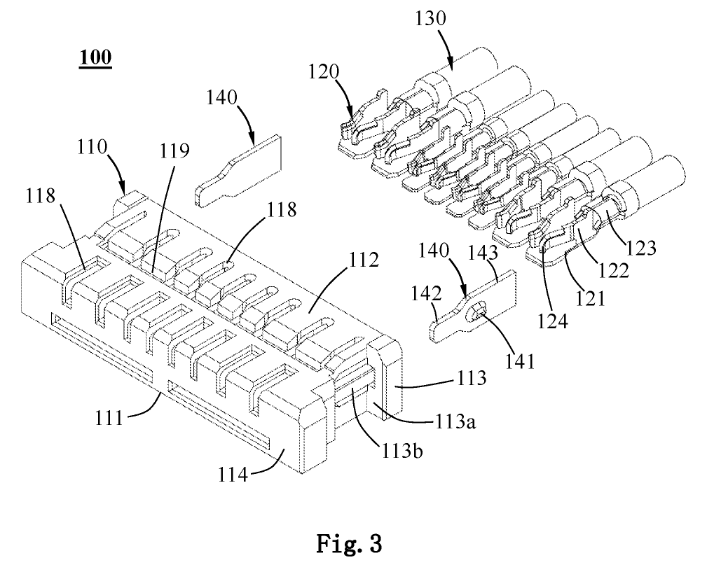

As shown in FIG. 3, the wire-end plug 100 includes an insulating body 110, a plurality of connecting terminals 120 fixed within the insulating body 110, a plurality of cables 130 connected to the connecting terminals 120, and a pair of locking members 140 inserted into the insulating body 110. The insulating body 110 is provided with a top wall 111, a bottom wall 112, a pair of side walls 113, a front end wall 114, and a rear end wall 115. The top wall 111 and the bottom wall 112 correspond to each other vertically and are parallel to each other, and a plurality of terminal slots 116 are formed between them. The plurality of terminal slots 116 penetrate forward through the front end wall 114 and penetrate rearward through the rear end wall 115 to form a plurality of wire outlet holes 117 on the rear end wall 115 for the cables 130 to pass through. The surface of the top wall 111 is a flat surface. Two rows of notches 118 are formed on the bottom wall 112. The two rows of notches 118 are separated by a groove 119. The two rows of notches 118 are formed by the terminal slots 116 penetrating through the bottom wall 112. A recessed portion 113a and a beam portion 113b located within the recessed portion 113a are formed on the pair of side walls 113. The top surface of the beam portion 113b is lower than the top wall 111. The connecting terminal 120 is provided with a base plate 121, a pair of contact clips 122 upwardly bent from both sides of the base plate 121, and a wire clamping portion 123 connected to the rear end of the base plate 121. The base plate 121 is horizontally disposed above or below the pair of contact clips 122. Front ends of the pair of contact clips 122 are provided with a pair of contact arms 124 arranged close to each other. The projection of the contact arm 124 in the vertical direction completely falls on the base plate 121. The pair of locking members 140 are plate-shaped and inserted into the side wall 113 along the front-rear direction. The locking member 140 is vertically disposed within the side wall 113 and exposed within the recessed portion 113a. An outwardly protruding protrusion 141 is provided on the outer surface of the locking member 140. The protrusion 141 is located within the recessed portion 113a and used for snap-fit connection with the board-end socket 200. Preferably, the locking member 140 is provided with a relatively narrow front end portion 142 and a relatively wide rear end portion 143. The width dimension of the former in the vertical direction is smaller than that of the latter in the vertical direction, meaning the locking member 140 is narrow at the front and wide at the rear. This facilitates insertion of the front end portion 142 into the side wall 113. The protrusion 141 is formed on the relatively wide rear end portion 143.

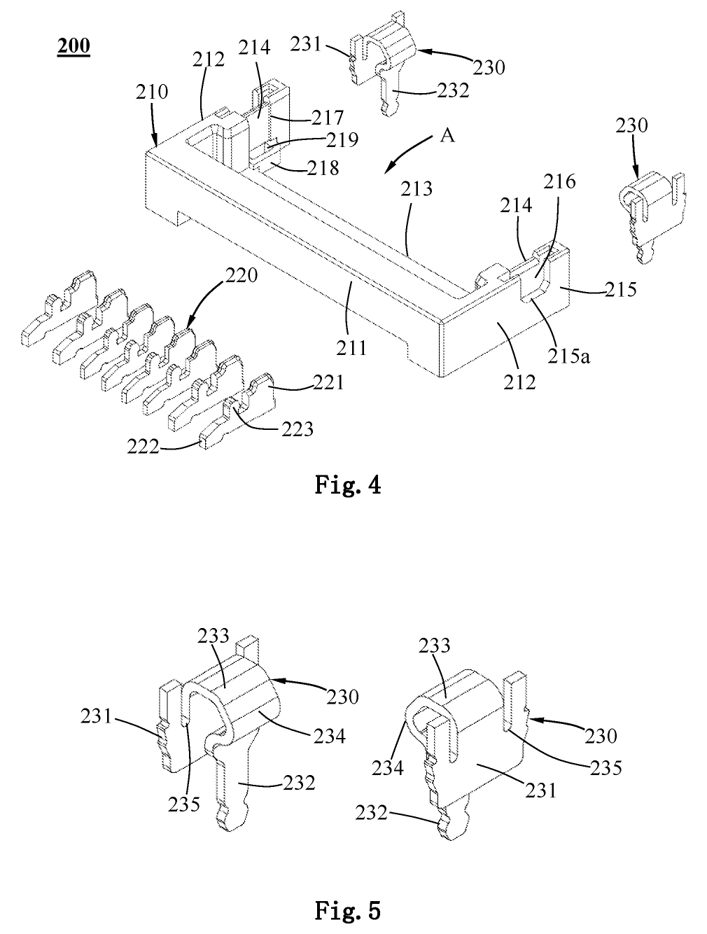

As shown in FIG. 4, the board-end socket 200 includes an elongated plastic base body 210, a plurality of sheet-shaped terminals 220 held on the plastic base body 210, and a pair of fixing members 230 mounted on the plastic base body 210. The plastic base body 210 is provided with a longitudinally extending main body 211, a pair of mounting arms 212 forwardly extending from the longitudinal ends of the main body 211, and a bottom plate 213 forwardly and horizontally extending from the bottom of the main body 211 and located between the pair of mounting arms 212. The main body 211, the bottom plate 213, and the mounting arms 212 are integrally connected and formed by integral injection molding. The pair of mounting arms 212 and the main body 211 constitute a U-shaped structure, and an inserting area A for accommodating the wire-end plug 100 is formed between them. An inner wall 214, an outer wall 215, and an inserting slot 216 between the inner wall 214 and the outer wall 215 are formed on the mounting arm 212. A recessed portion 217 is formed on the surface of the inner wall 214 facing the inserting area A. The inserting slot 216 and the recessed portion 217 together accommodate the pair of fixing members 230. Preferably, the mounting arm 212 is further provided with a limiting portion 218 located below the recessed portion 217. A limiting hole 219 is formed on the limiting portion 218 for fixedly limiting the fixing member 230. Preferably, an opening 215a recessed downward is formed on the outer wall 215. The opening 215a inwardly penetrates through the inserting slot 216. The sheet-shaped terminal 220 is F-shaped, and is provided with a contact portion 221, a soldering portion 222, and a holding portion 223. The contact portion 221 is sheet-shaped and vertically disposed on the bottom plate 213 for mating with the contact clips 122 of the wire-end plug 100. The pair of fixing members 230 are each provided with a sheet-shaped outer inserting plate 231 and an inner inserting foot 232 downwardly bent and extended from the top of the outer inserting plate 231. The inner inserting foot 232 and the outer inserting plate 231 are respectively located on the inner and outer sides of the inner wall 214. The outer inserting plate 231 is inserted into the inserting slot 216, while the inner inserting foot 232 is inserted into the recessed portion 217 and extends downward through the limiting hole 219 to be fixedly connected to the circuit board.

In the preferred embodiment of the disclosure, a pair of arms 233 extending upward are formed on both sides of the outer inserting plate 231 of the fixing member 230. The outer inserting plate 231 and the inner inserting foot 232 are integrally connected by an arc-shaped portion 233. The arc-shaped portion 233 is provided with an inwardly protruding snap-fit protuberant portion 234. The snap-fit protuberant portion 234 is used for snap-fit engagement with the protrusion 141 on the locking member 140. The arc-shaped portion 233 is located between the pair of arms 233, separated from them by slots 235. The provision of the slots 235 allows the arc-shaped portion 233 to have a certain deformation ability, thereby better adapting to the snap-fit operation with the locking member 140.

During assembly, the wire-end plug 100 is inserted into the inserting area A of the board-end socket 200 from top to bottom. Snap-fit engagement occurs between the pair of locking members 140 on the wire-end plug 100 and the pair of fixing members 230 on the board-end socket 200. Due to the provision of the protrusion 141 on the locking member 140, the engagement between the locking member 140 and the fixing member 230 achieves good snap-fit effect and operational feel. Since both are made of metal material, they possess better strength, resulting in stronger retention force between them, which may meet the requirements for frequent plugging and unplugging.

The above description is only the preferred embodiment of the disclosure and does not impose any formal limitations on the disclosure. Any person skilled in the art, within the scope of the technical solution of the disclosure, using the methods disclosed above to make many possible variations and modifications to the technical solution of the disclosure, may fall within the scope of protection defined by the claims.

1. A connector assembly, comprising a wire-end plug and a board-end socket that being mutually pluggable, the wire-end plug including an insulating body, a plurality of connecting terminals received within the insulating body, a plurality of cables connected to the connecting terminals, and a pair of locking members mounted on the insulating body; the board-end socket including a plastic base body, a plurality of sheet-shaped terminals held on the plastic base body, and a pair of fixing members mounted on the plastic base body; wherein each locking member is plate-shaped and has a protrusion provided on its surface, each fixing member is provided with a sheet-shaped outer inserting plate and an inner inserting foot downwardly bent and extended from a top of the outer inserting plate, the outer inserting plate and the inner inserting foot are integrally connected by an arc-shaped portion, and the arc-shaped portion is provided with a snap-fit protuberant portion that snap-fit engages with the protrusion.

2. The connector assembly according to claim 1, wherein the plastic base body is provided with a main body extending longitudinally, a pair of mounting arms forwardly extending from two longitudinal ends of the main body, and a bottom plate forwardly and horizontally extending from a bottom of the main body and located between the pair of mounting arms; an inner wall, an outer wall, and an inserting slot between the inner wall and the outer wall are formed on each mounting arm.

3. The connector assembly according to claim 2, wherein the pair of mounting arms and the main body constitute a U-shaped structure, and an inserting area for accommodating the wire-end plug is formed between the pair of mounting arms and the main body; a recessed portion is formed on the surface of the inner wall facing the inserting area, the recessed portion and the inserting slot are respectively located on the inner and outer sides of the inner wall and together accommodate the fixing member.

4. The connector assembly according to claim 3, wherein each mounting arm is further provided with a limiting portion located below the recessed portion, a limiting hole for accommodating the inner inserting foot is formed on the limiting portion.

5. The connector assembly according to claim 4, wherein an opening recessed downward is formed on the outer wall, the opening inwardly penetrates through the inserting slot.

6. The connector assembly according to claim 5, wherein each sheet-shaped terminal is F-shaped, and is provided with a contact portion, a soldering portion, and a holding portion; the contact portion is sheet-shaped and vertically disposed on the bottom plate.

7. The connector assembly according to claim 1, wherein the insulating body is provided with a top wall, a bottom wall, a pair of side walls, a front end wall, and a rear end wall, a surface of the top wall is a flat surface, two rows of notches are formed on the bottom wall, the two rows of notches are separated by a groove.

8. The connector assembly according to claim 7, wherein a recessed portion and a beam portion located within the recessed portion are formed on the pair of side walls, a locking member is plate-shaped and inserted into a side wall along a front-rear direction, the locking member is vertically disposed within the side wall and exposed within the recessed portion; the protrusion is located within the recessed portion.

9. The connector assembly according to claim 8, wherein the locking member is provided with a narrow front end portion and a wide rear end portion, the protrusion is formed on the rear end portion.
